(19) United States
(12) Patent Application Publication
(10) Pub. No.: US 2019/0171694 A1
(43) Pub. Date: Jun. 6, 2019

(54) PREVIEW OF DOWNLOADABLE FONTS

(71) Applicant: Microsoft Technology Licensing, LLC, Redmond, WA (US)

(72) Inventors: Niklas BORSON, Redmond, WA (US); Xueyun ZHU, Redmond, WA (US); Worachai CHAOWEERAPRASIT, Redmond, WA (US)

(21) Appl. No.: 15/829,233

(22) Filed: Dec. 1, 2017

(51) Int. Cl. G06F 17/21

(52) U.S. Cl. CPC G06F 17/214; G06F 17/212

(57) ABSTRACT

Methods and devices for previewing downloadable fonts may include receiving a preview font request for a visual representation of at least one font on a display. The methods and devices may include determining whether the at least one font is a locally stored font on the computer device or a downloadable font. The methods and devices may include retrieving, from a preview font file on the computer device, a preview instance that includes one or more glyph outlines to visually represent the at least one font when the at least one font is a downloadable font. The methods and devices may include transmitting the preview instance for presentation on the display.

### BACKGROUND

The present disclosure relates to previewing fonts.

Generally, to reduce an operating system (OS) storage footprint, many fonts may not be installed locally on every device, but can be downloaded on demand from the cloud. When users want to access remote downloadable fonts, users should be able to browse the downloadable fonts. However, for downloadable fonts, the usual approach of simply drawing some text in the represented font does not work for fonts not already installed on the device.

Thus, there is a need in the art for improvements in previewing fonts to show a visual representation of a font without having to download the font first to a device.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

One example implementation relates to a computer device. The computer device may include a memory to store data and instructions, a processor in communication with the memory, an operating system in communication with the memory and the processor, and a text and font manager in communication with the operating system, the memory, and the processor. The text and font manager may be operable to receive a preview font request for a visual representation of at least one font on a display; determine whether the at least one font is a locally stored font on the computer device or a downloadable font; retrieve, from a preview font file on the computer device, a preview instance that includes one or more glyph outlines to visually represent the at least one font when the at least one font is a downloadable font; and transmit the preview instance for presentation on the display.

Another example implementation relates to a method for previewing downloadable fonts. The method may include receiving, at a text and font manager on the computer device, a preview font request for a visual representation of at least one font on a display. The method may include determining whether the at least one font is a locally stored font on the computer device or a downloadable font. The method may include retrieving, from a preview font file on the computer device, a preview instance that includes one or more glyph outlines to visually represent the at least one font when the at least one font is a downloadable font. The method may include transmitting the preview instance for presentation on the display.

Another example implementation relates to computer-readable medium storing instructions executable by a computer device. The computer-readable medium may include at least one instruction for causing the computer device to receive a preview font request for a visual representation of at least one font on a display. The computer-readable medium may include at least one instruction for causing the computer device to determine whether the at least one font is a locally stored font on the computer device or a downloadable font. The computer-readable medium may include at least one instruction for causing the computer device to retrieve, from a preview font file on the computer device, a preview instance that includes one or more glyph outlines to visually represent the at least one font when the at least one font is a downloadable font. The computer-readable medium may include at least one instruction for causing the computer device to transmit the preview instance for presentation on the display.

Additional advantages and novel features relating to implementations of the present disclosure will be set forth in part in the description that follows, and in part will become more apparent to those skilled in the art upon examination of the following or upon learning by practice thereof.

### DESCRIPTION OF THE FIGURES

In the drawings:

FIG. 1 is a schematic block diagram of an example computer device in accordance with an implementation of the present disclosure;

FIG. 2 is an example mapping table used by a computer device to retrieve preview instances of a requested font in accordance with an implementation of the present disclosure;

FIG. 3 is an example method flow for creating a preview font file with a preview font in accordance with an implementation of the present disclosure;

FIG. 4 illustrates example font preview and preview instances displayed on a computer device in accordance with an implementation of the present disclosure;

FIG. 5 is an example method flow for previewing downloadable fonts in accordance with an implementation of the present disclosure; and

FIG. 6 is a schematic block diagram of an example device in accordance with an implementation of the present disclosure.

### DETAILED DESCRIPTION

This disclosure relates to devices and methods for displaying visual representations of downloadable fonts without first downloading the font files to a computer device. Instead of downloading every font available for use on a computer device, the computer device may download a single preview font file that contains preview instances of several remote downloadable fonts. The preview instances of the fonts may visually represent the available fonts for download. The preview instances may be scalable images represented as a sequence of glyph outlines. Different preview instances may be defined for each language (e.g., French, Japanese, etc.) of each typographic family (e.g., Arial, Georgia Pro, etc.) of the downloadable fonts included in the preview font file. In addition, the same preview instance may be used to represent different languages that are written in the same script. For example, English, French, and German may all be written using a Latin script and may share the same preview instance to visually represent the different languages. Thus, a user may use the preview font file to find a font they may want to download to the computer device.

The preview font file may be cached locally on the computer device and updated periodically to keep the preview font file synchronized with a catalog of available downloadable fonts. The preview font file may be significantly smaller than the collective size of the fonts represented by the preview font file. As such, a plurality of remote fonts may be visually represented on the computer device in an efficient manner without downloading the fonts to the computer device, resulting in a significant storage savings on the computer device.

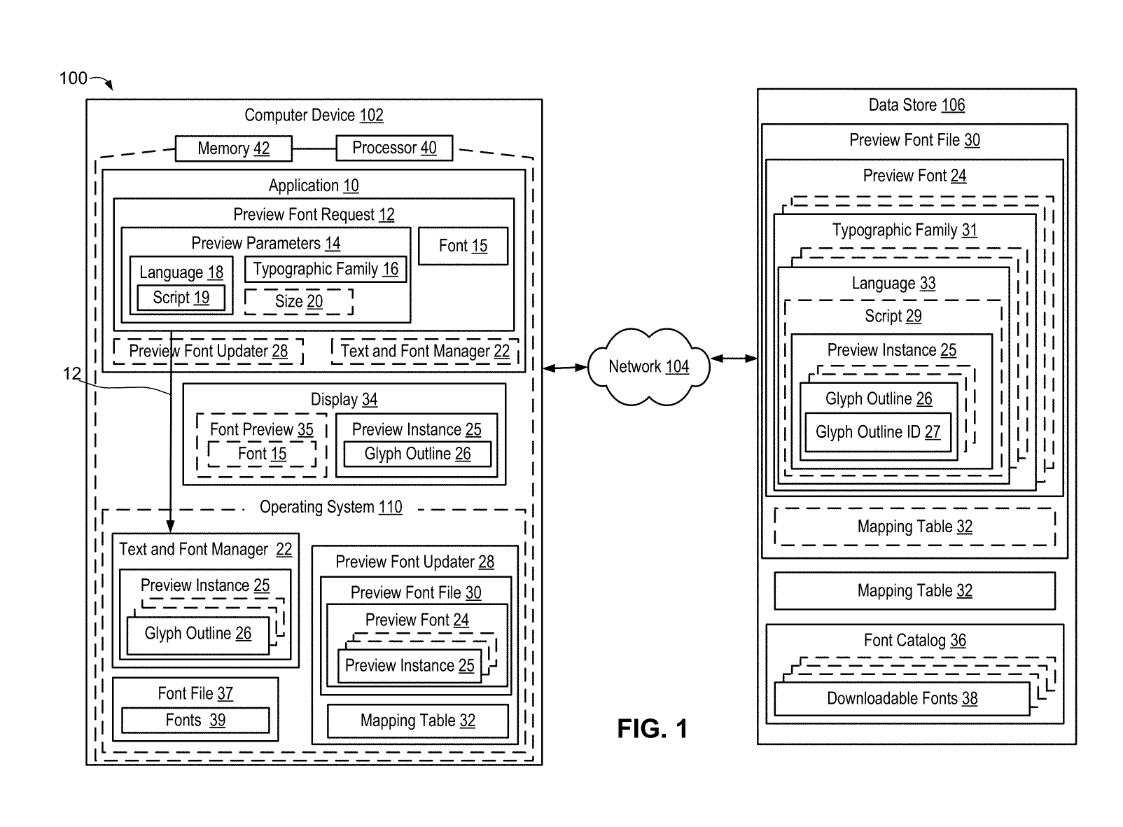

Referring now to FIG. 1, an example system 100 for use with previewing downloadable fonts may include a computer device 102 in communication with a remote data store 106 via a network 104. Network 104 may include any wireless and/or wired communications network. The data store 106 may be, for example, a cloud based data repository that may include at least one preview font file 30 with a preview font 24. Preview font 24 may be used to visually represent a plurality of downloadable fonts 38 included in a font catalog 36.

Preview font 24 may include a plurality of preview instances 25 for each language 33 of a typographic family 31 of the downloadable fonts 38 included in the preview font 24. Each language 33 of a typographic family 31 may be written in one or more scripts 29. For example, English may be written using a Latin script, while Serbian may be written in using a Latin or Cyrillic script. As such, the one or more preview instances 25 may correspond to each of the scripts 29 associate with the languages 33. In addition, the one or more preview instances 25 may correspond to a combination of the languages 33 and/or scripts 29 included in the preview font 24. Preview instances 25 may include, for example, a specific scalable image presented as a sequence of glyph outlines 26 in the preview font 24. The selected sequence of glyph outlines 26 may be based on preview text that includes a selection of characters (e.g., A, b, g) to visually represent the downloadable fonts 38. The preview text may differ depending on the design language 33 and/or script 29 the preview is intended to visually represent and/or for specific fonts, such as symbol fonts. As such, different downloadable fonts 38 may have different preview text selected for the visual representation. There may be one preview instance 25 for each design language 33 (e.g., German, Chinese, Hebrew, etc.) of each typographic family 31 (e.g., Arial, Times New Roman, Georgia Pro, etc.) of the downloadable fonts 38. In addition, the same preview instance 25 may be shared among different languages 33 that, for example, share the same script 29. For example, French, English, German, and Spanish are all languages that may be written in Latin script. The same preview instance 25 may be shared among the different languages to visually represent the downloadable fonts 38 in the different languages. Thus, a plurality of downloadable fonts 38 may be visually represented using the preview instances 25.

Preview font file 30 may also include a mapping table 32 that stores an association between the glyph outlines 26 and the typographic families 31 and languages 33 that the glyph outlines 26 represent. Mapping table 32 may be used to retrieve the corresponding glyph outlines 26 for a requested font to include in the preview instance 25 to visually represent the requested font. In addition, mapping table 32 may be separate from preview font file 30.

As new downloadable fonts 38 are included and/or removed from font catalog 36, preview font file 30 may be dynamically updated so that preview font 24 may remain synchronized with the downloadable fonts 38 currently included in font catalog 36. Font catalog 36 may include information about the downloadable fonts 38 available, for example, through a content delivery network (CDN) that may host the downloadable fonts 38, as well as related metadata used for font streaming. Preview font file 30 may be transmitted to computer device 102, for example, via network 104. In an implementation, preview font file 30 may be preloaded on computer device 102 by, for example, a device manufacturer. For example, the preview font file 30 may be created as part of the development process for computer device 102 and may be published to computer device 102 prior to computer device 102 shipping to a user.

Computer device 102 may include an operating system 110 executed by processor 40 and/or memory 42 of computer device 102. Memory 42 may be configured for storing data and/or computer-executable instructions defining and/or associated with operating system 110, and processor 40 may execute operating system 110. An example of memory 42 can include, but is not limited to, a type of memory usable by a computer, such as random access memory (RAM), read only memory (ROM), tapes, magnetic discs, optical discs, volatile memory, non-volatile memory, and any combination thereof. An example of processor 40 can include, but is not limited to, any processor specially programmed as described herein, including a controller, microcontroller, application specific integrated circuit (ASIC), field programmable gate array (FPGA), system on chip (SoC), or other programmable logic or state machine. Computer device 102 may include any mobile or fixed computer device, which may be connectable to a network. Computer device 102 may be, for example, a computer device such as a desktop or laptop or tablet computer, a cellular telephone, a gaming device, a mixed reality or virtual reality device, a music device, a television, a navigation system, a camera, a personal digital assistant (PDA), or a handheld device, or any other computer device having wired and/or wireless connection capability with one or more other devices.

Operating system 110 may include a preview font updater 28 operable to receive preview font file 30 from data store 106 so that the preview instances 25 for the downloadable fonts 38 may be stored locally on computer device 102. Preview font updater 28 may periodically retrieve preview font file 30 from data store 106 so that the preview instances 25 stored locally on computer device 102 may represent the current downloadable fonts 38 in the font catalog 36 (e.g., preview font file 30 may remain synchronized with the downloadable fonts 38). Preview font updater 28 may also receive mapping table 32. For example, mapping table 32 may be included as part of preview font file 30 and/or mapping table 32 may be a separate file received by preview font updater 28 along with preview font file 30. In addition, computer device 102 may include a font file 37 that stores the fonts 39 already downloaded on computer device 102.

Computer device 102 may also include a plurality of applications 10 (e.g., up to n applications, where n is a positive number) executed or processed by processor 40 and/or memory 42 of computer device 102. In an implementation, applications 10 may include preview font updater 28. Applications 10 may want to draw a preview of one or more fonts 15. For example, a user of application 10 may request to see a preview of a font 15 before selecting the font 15 for use. In addition, application 10 may want to present to a user a list of fonts 15 that may be available to the user. As such, applications 10 may generate a preview font request 12 to preview one or more fonts 15.

The preview font request 12 may include one or more preview parameters 14, such as, but not limited to, a typographic family 16, a language 18, a script 19, and/or a size 20 of the selected font 15. For example, a user may be creating a presentation and may want to select a different font to use in completing the presentation. The user may specify a typographic family 16, a language 18 and/or a script 19 that the user may want to preview before selecting the different font to use. For example, the user may specify Arial as the typographic family 16 and French as the language 18.

In an implementation, the script 19 may be automatically selected based upon the language 18 identified. For example, the input language may be specified as an Internet Engineering Task Force (IETF) language tag, and the system may automatically identify the script 19 from the IETF language tag. Some languages 18 may only be written in one script 19. For example, English may always be written in Latin script. As such, when a user requests English as language 18, Latin may automatically be selected for script 19. For other languages 18 that may be written in multiple scripts 19, application 10 and/or a user may specify a script 19 to use. For example, a user may specify Arial as the typographic family 16, Serbian as the language 18, and Cyrillic as the script 19.

In addition, the user may specify a size 20 of the font that the user may want to use. For example, the user may want to preview a font size 24. When application 10 is requesting a plurality of fonts 15 to preview, the preview parameters 14 included in the preview font request 12 may be default values for the fonts 15. Thus, the preview parameters 14 included in the preview font request 12 may include, a typographic family 16, a language 18, a script 19, and/or a size 20 of the specified font(s) 15.

Application 10 may transmit the preview font request 12 to a text and font manager 22 that may receive the preview font request 12 and coordinate the visual representation of the requested font 15. In an implementation text and font manager 22 may be included as part of application 10. In another implementation text and font manager 22 may be included as part of operating system 110. As such, the coordination of the visual representation of the requested font 15 may occur as part of application 10, operating system 110, and/or by a middleware component, such as, a web browser.

Text and font manager 22 may access font file 37 to determine whether the requested font 15 may be stored locally on computer device 102. For example, fonts locally stored on computer device 102 may have been preloaded on the computer device 102 by a device manufacturer. In addition, fonts locally stored on computer device 102 may have been previously downloaded by a user of computer device 102 for use on computer device 102.

When a match occurs between the requested font 15 and a font 39 stored in font file 37, text and font manager 22 may coordinate with a central processing unit (CPU) and/or a graphics processing unit (GPU) of computer device 102 to render a font preview 35 of the requested font 15. When the requested font 15 is stored locally on computer device 102, the font preview 35 may be, for example, a multiple line sample sentence of the requested font 15. Text and font manager 22 may transmit the font preview 35 of the selected font 15 to a display 34 for presentation to a user.

When a match does not occur between the requested font 15 and at least one font 39 in font file 37 (e.g., the requested font 15 is not already downloaded on computer device 102), text and font manager 22 may access preview font file 30 to determine a preview instance 25 that corresponds to the requested font 15. Text and font manager 22 may use the preview parameters 14 to retrieve the corresponding preview instances 25 for the requested font 15 from preview font file 30. The preview instances 25 may be strings of characters tailored to each language 33 of the requested font 15 (e.g., one or more sentences in the requested language). In an implementation, the preview instances 25 may be scalable images represented as a sequence of glyph outlines 26. By using a sequence of glyph outlines 26 in the preview instances 25 to represent the requested font 15, the requested font 15 may be visually represented using a short string of the preview text (e.g., the input characters selected to visually represent the requested font 15), enabling one preview instance 25 to be used for multiple languages 33 that share the same script 29. As such, a significance storage savings may occur in the preview font file 30 by using preview instances 25 with a short string of the preview text compared to the multiple line sample sentence used the fonts 39 already downloaded on computer device 102.

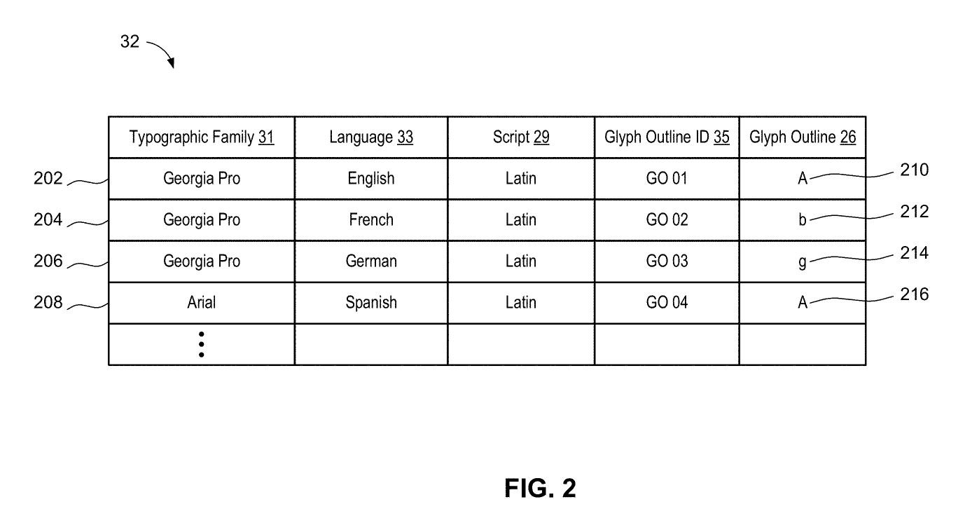

Text and font manager 22 may use the preview parameters 14 and the mapping table 32 to identify the one or more glyph outlines 26 for the preview instances 25 corresponding to the requested font 15. An example mapping table 32 is illustrated in FIG. 2.

Referring now to FIG. 2, mapping table 32 may include an association between a typographic family 31, a language 33, a script 29, a glyph outline ID 27 and a glyph outline 26. Mapping table 32 may be used to retrieve a corresponding glyph outline 26 for a requested font 15 (FIG. 1) to preview. For example, if a user requests Georgia Pro as the requested typographic family 16 and English as the requested language 18 of a font 15 to preview, rows 202, 204, and 206 of mapping table 32 may be used to retrieve the corresponding glyph outlines 26 (e.g., “A” 210, “b,” 212 and “g” 214) for Georgia Pro based on the same Latin script to include in the preview instance 25. In addition, if a user requests Arial as the requested typographic family 16, Spanish as the requested language 18, and Latin as the requested script 29 of the font 15 to preview, row 208 of mapping table 32 may be used to retrieve the corresponding glyph outline 26 (e.g., “A” 216) to include in preview instance 25. As such, different preview instances 25 may be generated for each language 33. For example, a preview instance 25 may generate a set of characters and/or a sentence in the requested language 33.

In addition, mapping table 32 may group similar typographic families 31 and/or languages 33 of the downloadable fonts 38 together so that a best match may be selected to visually represent a requested language 18. For example, similar typographic families 31 and/or languages 33 that use the same script 29 may be visually represented using the same glyph outlines 26. Mapping table 32 may associate the same glyph outline IDs 27 and/or glyph outlines 26 to different typographic families 31 and/or languages 33. As such, the same preview instances 25 may be shared among different languages 33 when, for example, different languages 33 use the same script 29. For example, French, English, German, and Spanish are all different languages 33, but each of these languages may be written using the Latin script 29. Thus, the same preview instance 25 may be shared between French, English, German, and Spanish. By sharing one preview instance 25 among different languages 33, the number of preview instances 25 required to visually represent the different fonts may be consolidated, resulting in a reduction in an amount of space needed for preview font file 30.

In an implementation, mapping table 32 may be a relational database that contains mapping data for multiple preview fonts 24. Text and font manager 22 may query mapping table 32 and may receive a uniform resource locator (URL) of the preview font 24 along with information about one or more preview instances 25 within the preview font 24.

Referring back to FIG. 1, text and font manager 22 may use the requested typographic family 31 and/or language 33 information to identify the one or more glyph outlines 26 that correspond to the requested font 15. Text and font manager 22 may coordinate with the CPU and/or the GPU of computer device 102 to render the preview instances 25 with the selected glyph outlines 26 to visually represent the requested font 15.

Text and font manager 22 may transmit the preview instances 25 with the selected glyph outlines 26 to a display 34 for presentation to a user. Display 34 may present the glyph outlines 26 of the preview instances 25 so that a user may see a visual representation of one or more remote downloadable fonts 38 using the preview instance 25 without having to download the downloadable fonts 38 to computer device 102.

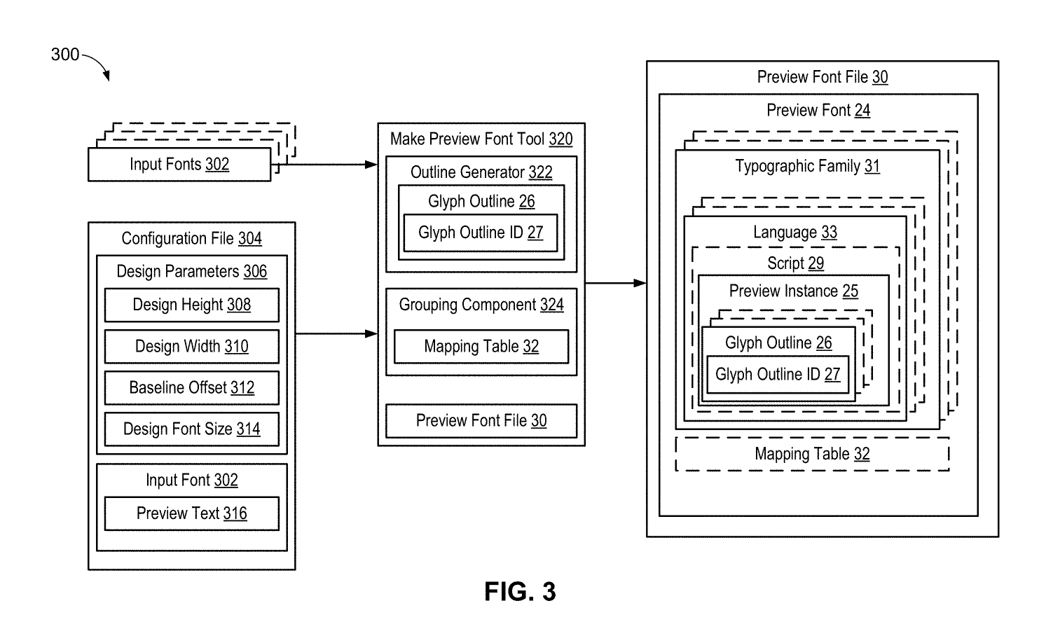

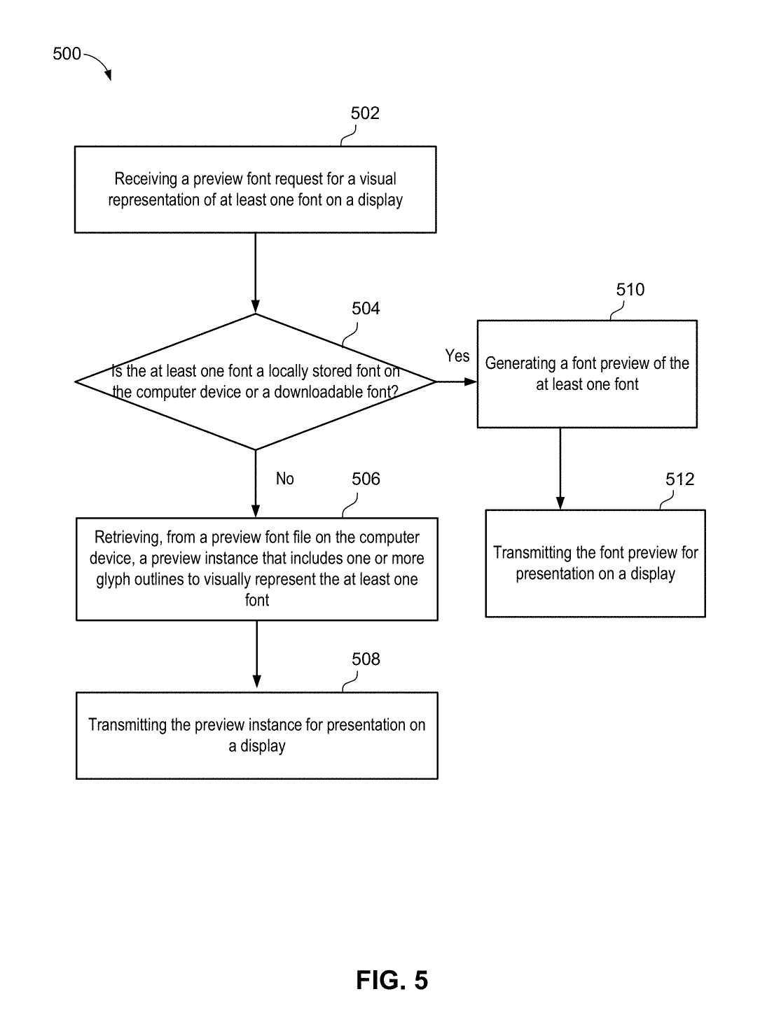

Referring now to FIG. 3, illustrated is an example method 300 for generating a preview font file 30 by a make preview font tool 320 to visually represent available downloadable fonts 38 for use, for example, by computer device 102 (FIG. 1). The make preview font tool 320 may be executed on a computer device with similar components as those discussed in connection with FIG. 5.

A plurality of inputs fonts 302 may be selected for inclusion in the preview font file 30. Input fonts 302 may include a variety of fonts a device manufacturer may not want to preload onto a computer device in order to reduce an amount of storage space used on the device relating to fonts. As such, the device manufacture may want to provide an option to download the input fonts 302 to the computer device when a user may want to use the input fonts 302. In addition, input fonts 302 may also include fonts created by third parties that may be downloaded to a computer device for use by a user.

A make preview font tool 320 may receive the one or more input fonts 302 to include in the preview font file 30. The make preview font tool 320 may generate one or more preview instances 25 to visually represent the one or more input fonts 302.

The make preview font tool 320 may also receive a configuration file 304 with one or more design parameters 306 to use when generating preview instances 25 for each of the one or more input fonts 302. Design parameters 306 may include, for example, a design height 308 and a design width 310 of the tile (e.g., a layout box) the preview instances 25 may be designed to fit within when displayed. In addition, the design parameters 306 may include a baseline offset 312 so that the preview instances 25 may align on the same baseline in the tile. As such, each of the preview instances 25 may be designed to fit the same size tile and align to the same baseline in the tile when displayed.

Design parameters 306 may also include a design font size 314. The design font size 314 may be the em size of the preview text 316 of the input font 302, where the em size equals the design height. The design font size 314 may be chosen so that the preview text 316 fits comfortably in the tile. The same design font size 314 may be used for most fonts. However, some fonts, such as wider fonts, may need different design font sizes 314. For example, a Gaudy Stout design font size 314 may be set at a smaller size with a shortened preview text 316 to fit in the tile.

Configuration file 304 may also include a preview text 316 selected for the one or more input fonts 302. The preview text 316 may include text rendered in the input font 302 to generate a family preview of the input font 302. For example, the preview text 316 may include a selection of characters (e.g., A, b, g) to visually represent the input font 302. The preview text 316 may differ depending on the design language 33 and/or script 29 the preview is intended to visually represent and/or for specific fonts, such as symbol fonts. As such, different input fonts 302 may have different preview text 316 selected for the visual representation.

The make preview font tool 320 may include an outline generator 322 operable to generate one or more glyph outlines 26 for the received preview text 316. The outline generator 322 may use one or more metrics to define the shape and/or size of the glyph outlines 26 based on the one or more received design parameters 306 and/or preview text 316 for the input fonts 302. Metrics in the generated glyph outlines 26 may be defined such that the design height is one em, using, for example, the following equations:

$$\begin{matrix}ascent = \frac{baselineOffset}{designHeight} & ( 1 ) \\ descent = \frac{designHeight - baselineOffset}{designHeight} & ( 2 )\end{matrix}$$

The outline generator 322 may also scale the glyph outlines 26, for example, based on an assumption that the preview glyph run will ultimately be rendered with the em size equal to the design height 308. As such, rendering the preview glyph run (e.g., the sequence of glyph outlines 26 used to render a preview instance 25) at the design height 308 may yield the same visual size as rendering the original input font 302 and the design font size 314. The scaling factor used by the outline generator 322 may be defined with the following equation:

$$scaleFactor = \frac{designFontSize}{designHeight} \qquad ( 3 )$$

As such, the glyph outlines 26 of the preview instances 25 may be scaled so that the glyph outlines 26 may be rendered in the tiles and may visually represent the input fonts 302.

The make preview font tool 320 may also include a grouping component 324 that may group similar typographic families 31 and/or languages 33 of the input fonts 302 together. Similar typographic families 31 and/or languages 33 may be visually represented using the same glyph outlines 26. For example, languages 33 that are written using the same script 29 may be visually represented using the same glyph outlines 26. As such, the same glyph outline IDs 27 and/or glyph outlines 26 may be associated with different typographic families 31, languages 33, and/or scripts 29.

Grouping component 324 may also generate a mapping table 32 that stores an association between the glyph outlines 26, the glyph outline IDs 27, the typographic families 31, the languages 33, and/or the scripts 29 that the glyph outlines 26 represent. Mapping table 32 may be used to retrieve the corresponding glyph outlines 26 for a requested font to include in the preview instance 25 to visually represent the font.

Make preview font tool 320 may also generate a preview font file 30 that may include a preview font 24. Preview font 24 may be used to visually represent the plurality of input fonts 302. For example, preview font 24 may include a plurality of glyph outlines 26 used to visually represent input fonts 302.

Preview font 24 may also include a plurality of preview instances 25 for each language 33 of a typographic family 31 included in preview font 24. The one or more preview instances 25 may also correspond to each script 29 of the languages 33. In addition, the one or more preview instances 25 may correspond to a combination of the languages 33 and/or scripts 29 included in the preview font 24. Preview instances 25 may include, for example, a specific scalable image presented as a sequence of glyph outlines 26 in the preview font 24. There may be one preview instance 25 for each design language 33 (e.g., French, Chinese, Hebrew, etc.) of each typographic family 31 (e.g., Arial, Times New Roman, Georgia Pro, etc.) of input fonts 302. In addition, the same preview instance 25 may be shared among different languages 33 that use the same script 29. As such, a plurality of input fonts 302 may be visually represented using the preview instances 25.

Preview font file 30 may also include mapping table 32. Mapping table 32 may be used to retrieve the corresponding glyph outlines 26 for a requested font to include in the preview instance 25 to visually represent the requested font.

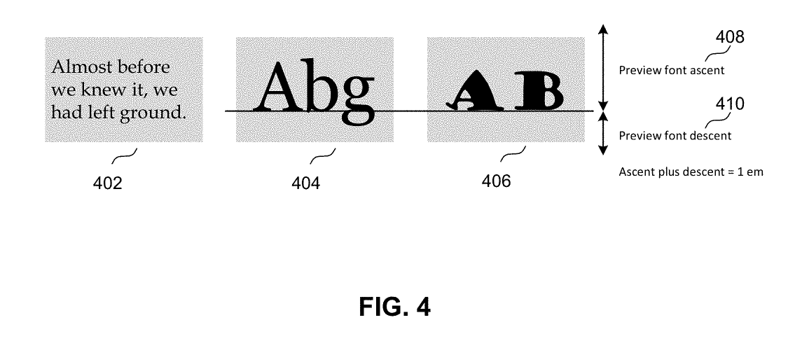

Referring now to FIG. 4, illustrated are example font previews 35 (FIG. 1) and preview instances 25 (FIG. 1) presented on display 34 (FIG. 1) of computer device 102 (FIG. 1). Display 34 may present tile 402 as a font preview 35 of a font 39 already downloaded on computer device 102. For example, the font preview 35 may include a sample sentence drawn at run time based at least upon a preview font request 12, as illustrated in tile 402.

In addition, display 34 may present tiles 404 and/or 406 as preview instances 25 of available remote downloadable fonts 38 without having to first download the downloadable fonts 38. For example, the preview instances 25 may be retrieved from a preview font file 30 on computer device 102. As illustrated in tiles 404 and/or 406, the preview instances 25 may be selected glyph outlines 26 of characters selected for the preview text of the downloadable fonts 38. In addition, the preview font ascent 408 and the preview font descent 410 may be chosen so that the preview text fits within the tiles 404 and/or 406. For example, equations (1), (2) discussed above in FIG. 3 may be used to calculate the preview font ascent 408 and/or the preview font descent 410.

Referring now to FIG. 5, an example method 500 may be used by computer device 102 to preview a remote downloadable font 38 (FIG. 1) without installing and/or downloading the remote downloadable font 38 to computer device 102.

At 502, method 500 may include receiving a preview font request for a visual representation of at least one font on a display. For example, a text and font manager 22 may receive a preview font request 12 with a requested font 15 from one or more applications 10 and may coordinate the visual representation of the requested font 15. Applications 10 may want to draw a preview of one or more fonts 15. For example, a user of application 10 may request to see a preview of a font 15 before selecting the font 15 for use. In addition, application 10 may want to present to a user a list of fonts 15 that may be available to the user. As such, applications 10 may generate a preview font request 12 to preview one or more fonts 15.

The preview font request 12 may include one or more preview parameters 14, such as, but not limited to, a typographic family 16, a language 18, a script 19, and/or a size 20 of the selected font 15. For example, a user may be creating a presentation and may want to select a different font to use in completing the presentation. The user may specify a typographic family 16, a language 18, and/or a script 19 that the user may want to preview before selecting the different font to use. For example, the user may specify Arial as the typographic family 16 and French as the language 18. In addition, the user may specify a size 20 of the font that the user may want to use. For example, the user may want to preview a font size 24. When application 10 is requesting a plurality of fonts 15 to preview, the preview parameters 14 included in the preview font request 12 may be default values for the fonts 15. Thus, the preview parameters 14 included in the preview font request 12 may include, a typographic family 16, a language 18, a script 19, and/or a size 20 of the specified font(s) 15.

At 504, method 500 may include determining whether the at least one font is a locally stored font on the computer device or a downloadable font. For example, text and font manager 22 may access font file 37 to determine whether the requested font 15 may be stored locally on computer device 102. For example, fonts locally stored on computer device 102 may have been preloaded on the computer device 102 by a device manufacturer. In addition, fonts locally stored on computer device 102 may have been previously downloaded by a user of computer device 102 for use on computer device 102.

At 506, method 500 may include retrieving, from a preview font file on the computer device, a preview instance that includes one or more glyph outlines to visually represent the at least one font when a match does not occur between the at least one font and a locally stored font. When a match does not occur between the requested font 15 and at least one font 39 in font file 37 (e.g., the requested font 15 is not already downloaded on computer device 102), text and font manager 22 may access preview font file 30 on computer device 102 to determine a preview instance 25 that corresponds to the requested font 15. Text and font manager 22 may use the preview parameters 14 of the preview font request to retrieve the corresponding preview instances 25 for the requested font 15 from preview font file 30. The preview instances 25 may be strings of characters tailored to each language 33 of the requested font 15. In an implementation, the preview instances 25 may be scalable images represented as a sequence of glyph outlines 26. By using a sequence of glyph outlines 26 in the preview instances 25 to represent the requested font 15, the requested font 15 may be visually represented using a short string of the preview text (e.g., the input characters selected to visually represent the requested font 15), enabling one preview instance 25 to be used for multiple languages 33 that share the same script 29. As such, a significance storage savings may occur in the preview font file 30 by using preview instances 25 with a short string of the preview text compared to the multiple line sample sentence used the fonts 39 already downloaded on computer device 102.

In addition, text and font manager 22 may use the preview parameters 14 and a mapping table 32 to identify the one or more glyph outlines 26 for the preview instances 25 corresponding to the requested font 15. Mapping table may be included in the preview font file 30 and/or may be separate from preview font file 30. For example, text and font manager 22 may use the requested typographic family 31 and/or language 33 information to identify the one or more glyph outlines 26 that correspond to the requested font 15.

Text and font manager 22 may coordinate with the CPU and/or the GPU of computer device 102 to render the preview instances 25 with the selected glyph outlines 26 to visually represent the requested font 15.

At 508, method 500 may include transmitting the preview instance for presentation on t display. For example, text and font manager 22 may transmit the preview instances 25 with the selected glyph outlines 26 to a display 34 for presentation to a user. For example, display 34 may present the preview instance 25 in a tile. Display 34 may present the glyph outlines 26 of the preview instances 25 so that a user may see a visual representation of one or more remote downloadable fonts 38 using the preview instance 25 without having to download the downloadable fonts 38 to computer device 102.

At 510, method 500 may include generating a font preview of the at least one font when the at least one font is a locally stored font on the computer device. When a match occurs between the requested font 15 and a font 39 stored in font file 37 on the computer device, text and font manager 22 may coordinate with a central processing unit (CPU) and/or a graphics processing unit (GPU) of computer device 102 to generate a font preview 35 of the requested font 15. The font preview 35 may be, for example, a multiple line sample sentence of the requested font 15.

At 512, method 500 may include transmitting the font preview for presentation on a display. For example, text and font manager 22 may transmit the font preview 35 of the requested font 15 to a display 34 for presentation to a user. Display 34 may present the multiple line sample sentence of the requested font 15, for example, within a display tile.

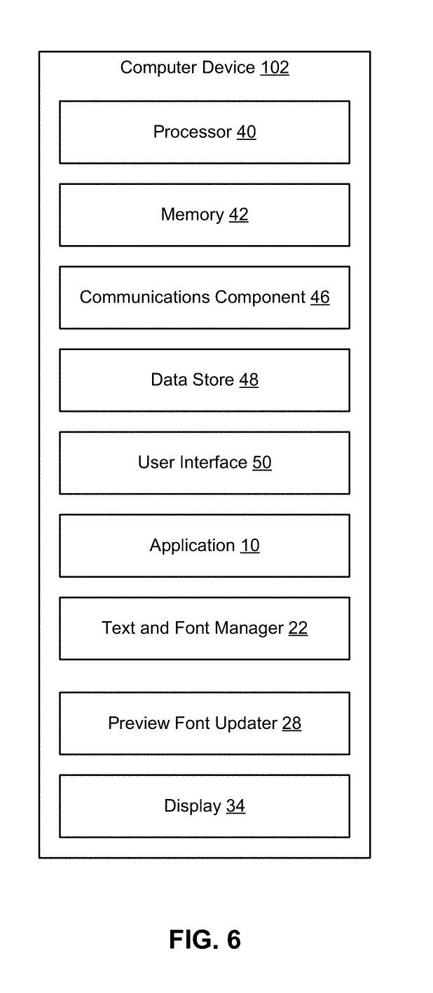

Referring now to FIG. 6, illustrated is an example computer device 102 in accordance with an implementation, including additional component details as compared to FIG. 1. In one example, computer device 102 may include processor 40 for carrying out processing functions associated with one or more of components and functions described herein. Processor 40 can include a single or multiple set of processors or multi-core processors. Moreover, processor 40 can be implemented as an integrated processing system and/or a distributed processing system.

Computer device 102 may further include memory 42, such as for storing local versions of applications being executed by processor 40. Memory 42 can include a type of memory usable by a computer, such as random access memory (RAM), read only memory (ROM), tapes, magnetic discs, optical discs, volatile memory, non-volatile memory, and any combination thereof. Additionally, processor 40 and memory 42 may include and execute operating system 110 (FIG. 1).

Further, computer device 102 may include a communications component 46 that provides for establishing and maintaining communications with one or more parties utilizing hardware, software, and services as described herein. Communications component 46 may carry communications between components on computer device 102, as well as between computer device 102 and external devices, such as devices located across a communications network and/or devices serially or locally connected to computer device 102. For example, communications component 46 may include one or more buses, and may further include transmit chain components and receive chain components associated with a transmitter and receiver, respectively, operable for interfacing with external devices.

Additionally, computer device 102 may include a data store 48, which can be any suitable combination of hardware and/or software, that provides for mass storage of information, databases, and programs employed in connection with implementations described herein. For example, data store 48 may be a data repository for applications 10 (FIG. 1), text and font manager 22 (FIG. 1), preview font updater 28 (FIG. 1), and/or display 34 (FIG. 1).

Computer device 102 may also include a user interface component 50 operable to receive inputs from a user of computer device 102 and further operable to generate outputs for presentation to the user. User interface component 50 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 50 may include one or more output devices, including but not limited to a display, a speaker, a haptic feedback mechanism, a printer, any other mechanism capable of presenting an output to a user, or any combination thereof.

In an implementation, user interface component 50 may transmit and/or receive messages corresponding to the operation of applications 10, text and font manager 22, preview font updater 28, and/or display 34. In addition, processor 40 executes applications 10, text and font manager 22, preview font updater 28, and/or display 34 and memory 42 or data store 48 may store them.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various implementations or features may have been presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some implementations, the processor and the storage medium may reside in an ASIC. Additionally, the ASIC may reside in a user terminal. In the alternative, the processor and the storage medium may reside as discrete components in a user terminal. Additionally, in some implementations, the steps and/or actions of a method or algorithm may reside as one or any combination or set of codes and/or instructions on a machine readable medium and/or computer readable medium, which may be incorporated into a computer program product.

In one or more implementations, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with examples disclosed herein.

1. A computer device, comprising:
a memory to store data and instructions;
a processor in communication with the memory;
an operating system in communication with the memory and the processor; and
a text and font manager in communication with the operating system, the memory, and the processer, wherein the text and font manager is operable to:
receive a preview font request for a visual representation of at least one font that is a downloadable font on a display;
retrieve, from a preview font file on the computer device, a preview instance that includes one or more glyph outlines to visually represent a selected preview text of the at least one font, wherein the selected preview text includes a subset of characters to visually represent the at least one font; and
transmit the preview instance for presentation on the display.

2. The computer device of claim 1, wherein the preview font file includes a plurality of preview instances that correspond to a language of each typographic family of downloadable fonts included in the preview font file.

3. The computer device of claim 2, wherein the one or more glyph outlines visually represent the selected preview text for the language of the typographic family.

4. The computer device of claim 2,
wherein the text and font manager is further operable to use a mapping table that associates the one or more glyph outlines to the language and the typographic family when retrieving the one or more glyph outlines to include in the preview instance.

5. The computer device of claim 1, wherein the preview font request includes one or more preview parameters for the at least one font.

6. The computer device of claim 5, wherein the one or more preview parameters include at least one or more of a typographic family, a language, and a font size.

7. The computer device of claim 6, wherein the preview instance corresponds to the typographic family and the language in the preview font request.

8. The computer device of claim 1, wherein the text and font manager is further operable to:
periodically check a remote data store for updates to available downloadable fonts from a font catalog on the remote data store; and
update the preview font file to correspond to the available downloadable fonts.

9. The computer device of claim 1, wherein the text and font manager is further operable to:
generate a font preview of the at least one font when the at least one font is a locally stored font, wherein the font preview is a multiline sentence visually representing the at least one font.

10. A method for previewing downloadable fonts, comprising:
receiving, at a text and font manager on the computer device, a preview font request for a visual representation of at least one font that is a downloadable font on a display;
retrieving, from a preview font file on the computer device, a preview instance that includes one or more glyph outlines to visually represent a selected preview text of the at least one font, wherein the selected preview text includes a subset of characters to visually represent the at least one font; and
transmitting the preview instance for presentation on the display.

11. The method of claim 10, wherein the preview font file includes a plurality of preview instances that correspond to a language of each typographic family of downloadable fonts included in the preview font file.

12. The method of claim 11, wherein the one or more glyph outlines visually represent the selected preview text for the language of the typographic family.

13. The method of claim 11, wherein a mapping table that associates the one or more glyph outlines to the language and the typographic family is used when retrieving the one or more glyph outlines to include in the preview instance.

14. The method of claim 10, wherein the preview font request includes one or more preview parameters for the at least one font.

15. The method of claim 14, wherein the one or more preview parameters include at least one or more of a typographic family, a language, and a font size.

16. The method of claim 15, wherein the preview instance corresponds to the typographic family and the language in the preview font request.

17. The method of claim 10, wherein the method further comprises:
periodically checking a remote data store for updates to available downloadable fonts from a font catalog on the remote data store; and
updating the preview font file to correspond to the available downloadable fonts.

18. The method of claim 10, wherein the method further comprises:
generating a font preview of the at least one font when the at least one font is a locally stored font, wherein the font preview is a multiline sentence visually representing the at least one font.

19. A computer-readable medium storing instructions executable by a computer device, comprising:
at least one instruction for causing the computer device to receive a preview font request for a visual representation of at least one font that is a downloadable font on a display;
at least one instruction for causing the computer device to retrieve, from a preview font file on the computer device, a preview instance that includes one or more glyph outlines to visually represent a selected preview text of the at least one font, wherein the selected preview text includes a subset of characters to visually represent the at least one font; and
at least one instruction for causing the computer device to transmit the preview instance for presentation on the display.

20. The computer device of claim 1, wherein a size of the preview font file is smaller than a collective size of the fonts represented by the preview font file.

21. The computer device of claim 1, wherein the text and font manager is further operable to:
receive a user decision to download the at least one font.
